(19) United States
(12) Patent Application Publication
(10) Pub. No.: US 2016/0271817 A1
(43) Pub. Date: Sep. 22, 2016

(54) ROTARY CUTTING DEVICE

(71) Applicant: Peter PATRICK, Southfield, MI (US)

(72) Inventor: Peter PATRICK, Southfield, MI (US)

(21) Appl. No.: 14/817,844

(22) Filed: Aug. 4, 2015

Related U.S. Application Data
(60) Provisional application No. 62/134,304, filed on Mar. 17, 2015.

(51) Int. Cl. B26B 25/00

(52) U.S. Cl. CPC B26B 25/005

(57) ABSTRACT

A pizza cutter is provided. The pizza cutter includes a first member that has a first handle. A rotary knife is pivotally attached to the first member such that the first member extends beyond the radius of the rotary knife. A second member, that also has a handle, is affixed to the first member such that the second member also extends beyond the radius of the rotary knife. The second member also extends in a direction relative to the first member such that an obtuse angle is formed between the first member and the second member.

### CROSS-REFERENCE TO RELATED APPLICATIONS

This application claims the benefit of U.S. provisional application No. 62/134,304 filed on Mar. 17, 2015, the disclosure of which is hereby incorporated in its entirety by reference herein.

### TECHNICAL FIELD

The present disclosure relates to rotary cutting devices including pizza cutters.

### BACKGROUND

Rotary cutting devices include a rotary knife that pivots about an axis in order to make a desired cut in an object such as a freshly baked pizza.

### SUMMARY

A rotary cutting device is provided. The rotary cutting device includes a base portion. A rotary knife is connected to the base portion by a pivot. A first member and a second member, each including a handle, protrude from the base portion and extend beyond the radius of the rotary knife. The second member protrudes from the base portion such that an angle of less than 180 degrees is formed between the first member and the second member.

A pizza cutter is provided. The pizza cutter includes a first member that has a first handle. A rotary knife is pivotally attached to the first member such that the first member extends beyond the radius of the rotary knife. A second member, that also has a handle, is affixed to the first member such that the second member also extends beyond the radius of the rotary knife. Additionally, the second member extends in a direction relative to the first member such that an obtuse angle is formed between the first member and the second member.

### BRIEF DESCRIPTION OF THE DRAWINGS

FIG. 1 is a side view of a first embodiment of a rotary cutting device;

FIG. 2 is a top view of the first embodiment of the rotary cutting device;

FIG. 3 is a side view of a second embodiment of the rotary cutting device;

FIG. 4 is a side view of a third embodiment of the rotary cutting device; and

FIG. 5 is a top view of a fourth embodiment of the rotary cutting device.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

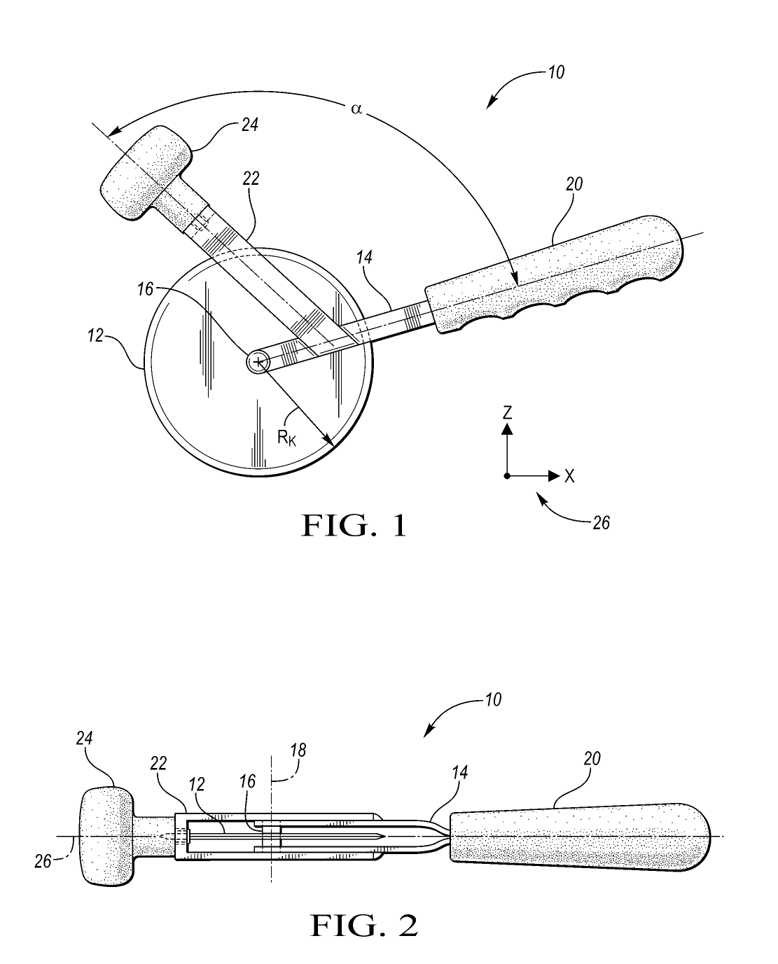

Referring to FIGS. 1 and 2, a first embodiment of a rotary cutting device 10 (or pizza cutter) is illustrated. FIG. 1 illustrates a side view of the rotary cutting device 10 and FIG. 2 illustrates a top view of the rotary cutting device 10. The rotary cutting device 10 includes a rotary knife 12. Preferably, rotary knife 12 is made of stainless steel with a thickness of 0.02 inches to 0.15 inches, a diameter of 2.0 inches to 5.0 inches, and a sharpened outer edge. The rotary knife 12 may be connected to a first member 14 such that the first member 14 extends beyond a radius Rₖ of the rotary knife 12. The rotary knife 12 may be connected to the first member by pivot 16 such that the rotary knife 12 may freely rotate about an axis 18 defined by the pivot 16. The pivot 16 may consist of a shaft that extends through apertures in the rotary knife 12 and first member 14 to secure the rotary knife 12 to the first member 14. The shaft may be press fit into at least one of the apertures in the rotary knife 12 and first member 14, or the shaft may include a retaining pin so that the shaft may be securely retained in the apertures in the rotary knife 12 and first member 14. In the alternative, the pivot 16 may consist of a fastener, such as a rivet or nut and bolt combination, which is fed through the apertures in the rotary knife 12 and first member 14 in order to secure the rotary knife 12 to the first member 14. The pivot 16 may also utilize a bushing in order to decrease the internal friction forces of the pivot 16. The pivot 16 should not be construed as limited to the pivots described herein but should include all pivoting devices known in the art that may be used to secure the rotary knife to the first member 14 such that the rotary knife 12 may freely pivot about the axis 18 defined by the pivot 16.

The first member 14 may include a first handle 20. The first handle 20 may also extend beyond the radius Rₖ of the rotary knife 12. The first handle 20 may be connected to the first member 14 by any conventional means. For example, the handle 20 may be connected to the first member 14 by an adhesive; a fastener (e.g., bolt, screw, rivet, etc.); one of the first handle 20 or first member 14 may include a threaded portion that is threaded into a tapped hole in the other of the first handle 20 or first member 14; the first handle 20 may be press fit to the first member 14; the first handle 20 may be a material, such as a plastic material, that overlays a portion of the first member 14 which may then be pressed or heat shrunk to the first member 14; or the first handle 20 may be affixed to the first member 14 by any other means known in the art.

A second member 22 may be affixed to the first member 14. The second member 22 may include a second handle 24. Second handle 24 may be connected to the second member 22 by any means known in the art including the examples above describing how the first handle 20 may be connected to the first member 14. The second member 22 may be affixed to the first member 14 such that the second member 22 extends beyond the radius Rₖ of the rotary knife 12. The second handle 24 may also extend beyond the radius Rₖ of the rotary knife 12. The second member 22 may extend in a direction relative to the first member 14 such that an angle α is formed between the first member 14 and second member 22. The angle α formed between the first member 14 and second member 22 may be an angle that is less than 180°, but is preferably an obtuse angle. More preferably the angle α may range between 100° and 170°. The angle α may be located on a plane defined by the radius Rₖ of the rotary knife 12. The plane defined by the radius Rₖ of the rotary knife 12 may also be referred to as the XZ plane 26 according to a defined coordinate system. The XZ plane 26 may include a plane on which the radius Rₖ of the rotary knife 12 lies or any plane that is parallel to the plane on which the radius Rₖ of the rotary knife 12 lies.

The first member 14 is shown having a fork design that straddles the rotary knife 12 and the second member 22 is shown having a fork design that straddles the first member 14. The disclosure should not be construed as limited to this configuration. For example, one of the two members 14, 22 may be a fork design that straddles the rotary knife 12 while the other of the two members 14, 22 is a single linear member. The single linear member may be straight throughout the entirety of its length or the single linear member may include offset portions. As yet another example, both members 14, 22 may consist of single members that may or may not include offsets.

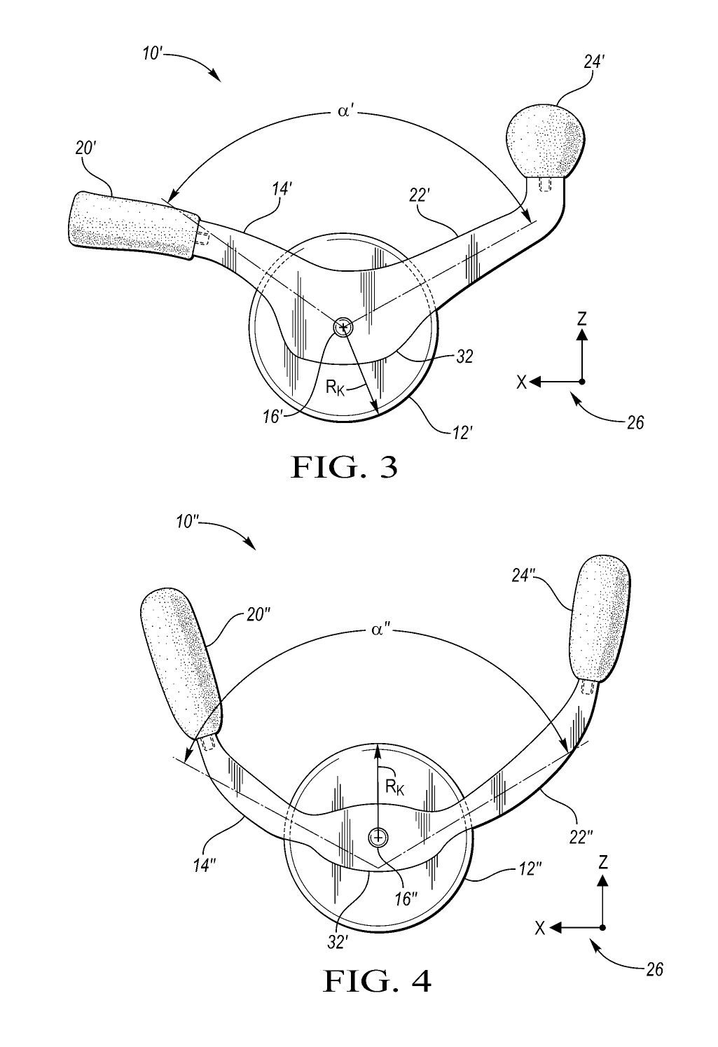

Referring to FIG. 3, a second embodiment of the rotary cutting device 10′ is illustrated. The second embodiment illustrates a first member 14′ and a second member 22′ both protruding from and affixed to a base portion 32 at an angle α′ relative to each other. A rotary knife 12′ is connected to the base portion 32 by a pivot 16′. The first member 14′ includes a first handle 20′ and the second member 22′ includes a second handle 24′.

Referring to FIG. 4, a third embodiment of the rotary cutting device 10″ is illustrated. The third embodiment illustrates a first member 14″ and a second member 22″ both protruding from and affixed to a base portion 32′ at an angle α″ relative to each other. A rotary knife 12″ is connected to the base portion 32′ by a pivot 16″. The first member 14″ includes a first handle 20″ and the second member 22″ includes a second handle 24″.

The first handle 20 in the first embodiment of FIG. 1 and the first handle 20′ in the second embodiment of FIG. 3 are shown as a long slender type handles, similar to the handles found on a carpenter hammer, manual parking brake in a car, or other type of device that requires a mechanical advantage, while the second handle 24 in the first embodiment and second handle 24′ in the second embodiment are shown as a knob type handles or pommels. In the third embodiment of FIG. 4, both the first handle 20″ and second handle 24″ are shown as long slender type handles.

The long slender type handle design may have a smooth surface, or include at least one indentation or finger groove to assist a user when gripping the handle. The knob type handle and pommel designs may include a variety of shapes including the mushroom shape illustrated in FIG. 1 and the substantially spherical shape illustrated in FIG. 3. The first handles and second handles of the first, second, third, and fourth (described below) embodiments may be any of the types of handles described herein or any other type of handle known in the art. The handles may be made from a material, such as a soft plastic or rubber that has a higher coefficient of friction, allowing a user to easily grip the handle. Alternatively, the handles may be made from a material chosen for its aesthetic appeal, such as a finished wood, a polished metal, or a hard plastic. The handles may be detachable and therefore interchangeable with other types of handles.

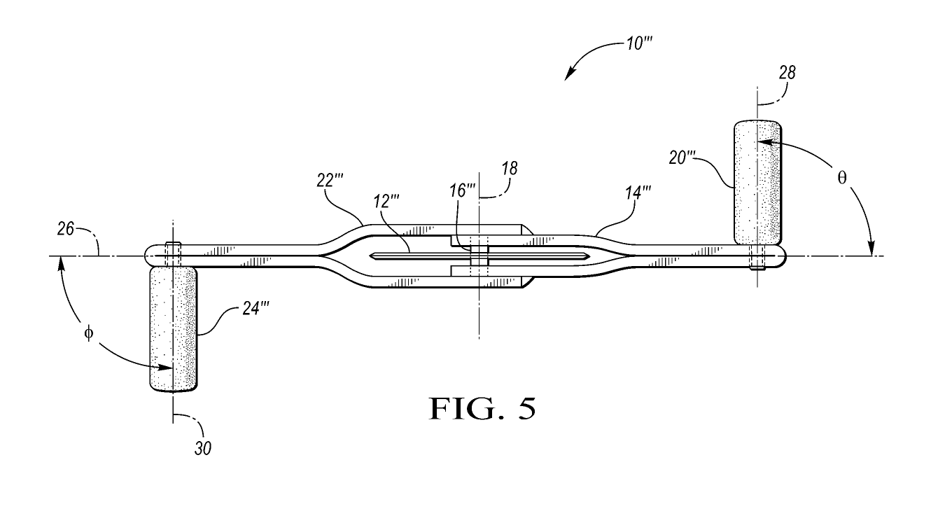

Referring to FIG. 5, an alternative fourth embodiment of the rotary cutting device 10′″ is illustrated. A first handle 20′″ is shown to extend from a first member 14′″ along a first axis 28 that is at a first angle Θ relative to the XZ plane 26, and the second handle 24′″ is shown to extend from the second member 22′″ along a second axis 30 that is at a second angle Φ relative to the XZ plane 26. The first angle Θ and the second angle Φ may range anywhere from 0° to 90° relative to the XZ plane 26. Although not illustrated in FIG. 5, the first member 14′″ and the second member 22′″ may include portions that extend at angles relative to the XZ plane 26, along with the first handle 20′″ or second handle 24′″. For example, in embodiments where the first handle 20′″ or second handle 24′″ is located at an angle relative to the XZ plane 26, and the first handle 20′″ or second handle 24′″ is a plastic material that overlays a portion of the first member 14′″ or second member 22′″, a portion of the first member 14′″ or second member 22′″ would necessarily also be located at an angle relative to the XZ plane.

In all of the described embodiments, the first handles 20 (including prime variations thereof) may be rotatably connected to the first members 14 (including prime variations thereof) allowing the first handle 20 to rotate relative to the first member 14. Additionally, in all of the described embodiments, the second handle 24 (including prime variations thereof) may be rotatably connected to the second member 22 (including prime variations thereof) allowing the second handle 24 to rotate relative to the second member 22.

It should be understood that the components in alternative embodiments that have like identifies or call-out numbers, whether one or more prime symbols (′) are included or not included, should be construed as having the same characteristics as the like numbers in the other embodiments unless otherwise indicated.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A rotary cutting device comprising:
a base portion;
a rotary knife connected to the base portion by a pivot;
a first member, having a first handle, protruding from the base portion and extending beyond a radius of the rotary knife; and
a second member, having a second handle, protruding from the base portion and extending beyond the radius of the rotary knife, wherein the second member protrudes from the base portion such that an angle of less than 180 degrees is formed between the first member and the second member.

2. The rotary cutting device of claim 1, wherein the angle between the first member and the second member is located on a plane defined by the radius of the rotary knife.

3. The rotary cutting device of claim 2, wherein the angle between the first member and the second member ranges from 100 to 170 degrees.

4. The rotary cutting device of claim 2, wherein the first handle extends along a first axis that is at a first angle relative to the plane defined by the radius of the rotary knife.

5. The rotary cutting device of claim 4, wherein the second handle extends along a second axis that is at a second angle relative to the plane defined by the radius of the rotary knife.

6. The rotary cutting device of claim 5, wherein the first angle ranges from 60 to 90 degrees and the second angle ranges from 60 to 90 degrees.

7. The rotary cutting device of claim 1, wherein at least one of the first handle or second handle is a pommel.

8. The rotary cutting device of claim 1, wherein the first handle is rotatably connected to the first member.

9. The rotary cutting device of claim 8, wherein the second handle is rotatably connected to the second member.

10. A pizza cutter comprising:
a first member having a first handle;
a rotary knife pivotally attached to the first member such that the first member extends beyond a radius of the rotary knife; and
a second member, having a second handle, affixed to the first member such that the second member also extends beyond the radius of the rotary knife, wherein the second member extends in a direction relative to the first member such that an obtuse angle is formed between the first member and the second member.

11. The pizza cutter of claim 10, wherein the obtuse angle is located on a plane defined by the radius of the rotary knife.

12. The pizza cutter of claim 11, wherein the obtuse angle ranges from 100 to 170 degrees.

13. The pizza cutter of claim 11, wherein the first handle extends along a first axis that is at a first angle relative to the plane defined by the radius of the rotary knife.

14. The pizza cutter of claim 13, wherein the second handle extends along a second axis that is at a second angle relative to the plane defined by the radius of the rotary knife.

15. The pizza cutter of claim 14, wherein the first angle ranges from 60 to 90 degrees and the second angle ranges from 60 to 90 degrees.

16. The pizza cutter of claim 15, wherein the first handle is rotatably connected to the first member.

17. The pizza cutter of claim 16, wherein the second handle is rotatably connected to the second member.

18. The pizza cutter of claim 10, wherein at least one of the first handle or second handle is a pommel.

19. A pizza cutting device comprising:
a rotary knife pivotally attached to a first handle and a second handle such that the first handle and the second handle extend beyond a radius of the rotary knife, wherein the first handle extends in a direction relative to the first handle such that an angle of less than 180 degrees is formed between the first handle and the second handle.

20. The pizza cutting device of claim 19, wherein the angle between the first handle and the second handle is located on a plane defined by the radius of the rotary knife.
